(19) United States
(12) Patent Application Publication
(10) Pub. No.: US 2002/0059340 A1
(43) Pub. Date: May 16, 2002

(54) DIGITAL GREETINGS

(76) Inventor: SHARI M. CENTRONE, CHICAGO, IL (US)

Correspondence Address: GARDNER, CARTON & DOUGLAS, 321 N. CLARK STREET, SUITE 3400, CHICAGO, IL, 60610, US

(21) Appl. No.: 09/169,813

(22) Filed: Oct. 9, 1998

(51) Int. Cl. G06F 17/00

(52) U.S. Cl. 707/501.1

(57) ABSTRACT

A digital multi-media greeting comprising a text component, a graphics component, and one or more of an audio component, an animation component, a sound component, a film component, an image component and a video component. The digital greeting contains an autoexecute function, and it is contained on a physical medium that is readable by a computer adapted to accept the medium, such as but not limited to CD-ROM. The greeting is displayed to the recipient on a digital display medium such as but not limited to a computer screen.

### BACKGROUND OF THE INVENTION

1. Field of the Invention

The present invention relates to greetings, and in particular a digitally displayed greeting which may be viewed using a digital viewing device such as but not limited to a computer.

2. Scope of the Prior Art

Greeting cards are well known in the art and are popular with the public. In 1997, over 7 billion greeting cards were purchased by consumers. Retail sales of greeting cards in the U.S. have increased dramatically over the last two decades, from 2.1 billion in 1978 to approximately 7.1 billion to 1997. It is customary for many different occasions for individuals to give each other greeting cards with printed messages or with messages handwritten by the sender, the messages being different for each different occasion. Greeting cards include invitations, cards expressing various emotions, greetings and sentiments, occasion cards such as but not limited to birthday cards, announcements and the like. The vast majority of these greetings are conventionally designed using printed words on a traditional medium (such as paper or mylar balloons and the like) to convey the desired message, and some cards may have additional features such as the ability to play a few bars of an appropriate tune such as “Happy Birthday.” In recent years, electronic forms of greeting cards have emerged such as greetings delivered over the Internet, or greetings delivered via “personal communicators” such as a telephone or alpha-numeric pager.

Traditional greeting cards suffer from the drawback of using a single means, the printed word, as the means of conveyance of the desired message. Virtually all cards utilize a graphical message as the primary means of communication, even cards targeted to preschool children who are unable to read.

Retailers typically display greeting cards on large racks, where the purchaser manually inspects the cards prior to purchase, generally handling more than one card. Frequently, the cards are damaged by such inspections, and a significant percentage of the cards in a typical display rack are smudged, bent or otherwise damaged by careless handling. In addition, matching envelopes for the cards must be stocked, which are also handled or mismatched by consumers. Keeping the greeting cards properly categorized and displayed with appropriate envelopes is a labor-intensive undertaking for the retailer. Moreover, retailers experience a significant amount of loss due to damage with traditional paper greeting cards. Lastly, a typical greeting card ranges in size from generally 5 inches by 8 inches to much larger. The face of each card is generally clearly displayed, causing retailers to devote large amounts of shelf space to greeting cards. A large amount of display space devoted to a single item generally results in that item being very expensive for the retailer to display. Lastly, traditional paper cards make a relatively poor keepsake, as such cards are fragile and must be carefully stored to protect against handling and deterioration.

In recent years, variations on the traditional printed greeting card have been introduced to the market, such as the ability to create personalized greeting cards with a machine. One patented machine for creating greeting cards includes a printer, a monitor and a processing unit which are housed in a display cabinet. The purchaser of the card responds to a variety of programmed prompts, and chooses from a menu of options such as typeface, printed greeting and artistic features. Once the purchaser has selected all the desired options, the card is printed and is ejected from the machine. While this invention is relatively compact compared to the average greeting card display and it eliminates the damage problems inherent in rack displays as described above, such machines require frequent maintenance, the cards are more expensive than traditional preprinted cards, the user is limited to a relatively few programmed options and the machines are time consuming to use. In addition, these machines may be difficult to use, particularly for those not technologically inclined. Because of these drawbacks, retailers who utilize a personalized card machine use the machine as a supplement, and not to replace, to traditional greeting card displays.

Other patented greeting-related devices include greeting cards delivered via Internet e-mail and greetings delivered to a “personal communicator.” These greetings are generally limited in format in that the Internet greetings must be contained in an electronic file of a size small enough to be successfully and conveniently sent and received via e-mail, so the delivery and viewing process must not slow or disable the computer system of the sender or the user. In addition, the format of the Internet greeting must be relatively generic to accommodate the wide variety of possible formats of recipient computer systems. These technical requirements generally limit the number of features that may be contained in the greeting, such as video, animation or sound, and may even limit the graphical portions of the greeting. Greetings sent via personal communicator are limited to plain text and audio. In addition, both of these methods of greetings suffer from the drawbacks of being relatively complicated to send (as compared to choosing an appropriate paper card from a rack and delivering it to the recipient), and the greeting sent is temporary and may not be used as a keepsake of an important event.

In addition to the drawbacks described above for single-medium greetings such as printed cards, or delivery of text via e-mail or deliver of an audible message, the dynamic nature of modern communications may be rendering single-medium greetings obsolete and uninteresting to the modern, technologically inclined recipient (such as the average 6 year old child).

Thus, while the foregoing prior art generally describes various greeting cards and display methods, none addresses the problem of providing durable, economical, easy-to-display keepsake greetings in a form which may be enjoyed by everyone, including young children and persons who cannot read.

In recent years, digital forms of display and communication such as digital-video technology (e.g., digital video disk commonly known as “DVD” technology) and compact disk—read only memory (i.e., CD-ROM technology) are becoming increasingly popular. Many works of art, music and literature are now being distributed on CD-ROM or DVD devices, to be used with personal computers having compatible peripheral devices such as CD-ROM and DVD drives. Such computers generally have the ability to translate or read digital information stored in the CD-ROMs and DVDs into graphical, sound and video displays on an appropriate digital display means. For instance, many popular movies, books and games are distributed via CD-ROM or DVD and are used in connection with a personal computer (“PC”) or suitably equipped television.

CD-ROM and other digitally stored works for use with a personal computer or other suitably equipped display means such as a television with graphical capabilities or a “network computing” device) are advantageous for many reasons, one of the most important being the ability to display and utilize multi-media works. Multi-media works are generally too large to be practically stored on the hard drive of a conventional PC by 1998 standards, but may be stored with ease on a CD-ROM or DVD or other digital technology. These multi-media works are advantageous for a number of reasons, one being that persons who are differentially-abled (such as children who cannot read, or persons who are sight or hearing impaired) may choose a display form which is compatible with the needs of the user. For instance, a vision-impaired person may prefer audible display methods, while a hearing-impaired person may choose graphical display methods. Multi-media is particularly useful for children, as they may be stimulated by artwork, a cartoon and sound, all in a single work. One example of a very successful class of multi-media works stored on a CD-ROM is an encyclopedia, which may combine text, sound, video and graphics.

As a result of the recent advances in creating “user-friendly” digital technology, large digital files containing many different communication components and in some cases, interactivity, have become commonplace, particularly among children. Many young children become adept at using computers even before they can read, and are capable of manipulating various types of technology such as computer disks or CD-ROM disks in a personal computer, or technology. Lastly, digital media such as but not limited to CD-ROM or DVD technology is tangible, very durable, and may be displayed in racks and inspected by multiple potential purchasers without harm.

In this age of multi-media (where more than one form of communication is used in a single message), a new dynamic format for greeting cards is desirable. Such multimedia greetings could appeal to persons of all ages and abilities because of the varied content therein. Accordingly, for the reasons discussed above, a digital format provides an excellent medium for creating and displaying greetings, which is the subject of this invention.

### SUMMARY OF THE INVENTION

The present invention includes one or more software files comprising one or more of graphics, text, video, animation, sound, images such as photographic images or other components contained on a digital medium such as a CD-ROM disk or other multi-media digital storage device. The computer files may be run on compatible digital actuating systems adapted to accept the medium such as but not limited to PCs equipped with PC-compatible operating systems such as but not limited to DOS (“Digital Operating System”) and Windows® (or their variations or future counterparts). The digital actuating systems may optionally be automatically displayed using an “auto-run” feature in the recipient's computer, or the files may be executed by manually pressing the appropriate keys or buttons on the computer or keyboard. The greeting is displayed to the recipient on a digital display medium.

The aggregate software files of the invention are large by current standards and are thus currently optimally adaptable to CD-ROM or digital-video media, but other media may become available in the future and such advancements in media are contemplated as being within the scope of the present invention.

Accordingly, it is the object of this invention to provide the user with a digitally displayed greeting.

It is another object of the invention to provide a greeting which could be a lasting keepsake that is less fragile than traditional printed greeting cards.

Another object of the invention is to create a greeting which may be viewed using a digital actuating system such as but not limited to a personal computer.

It is also an object of the invention to provide a digital greeting card which contains one or more components of text, audio, animation, video, images, or other artwork.

Lastly, it is an object of the invention to provide a greeting which is less labor intensive for retailers to display and maintain and which is minimizes product loss of retailers.

These and other advantages, features and objects of the present invention will be more readily understood and obvious to those skilled in the art, and such other features and objects are within the scope of the present invention. In particular it is noted that software and related hardware are constantly evolving and that particular items may become obsolete in a short timespan. It is thus anticipated that future product and functional equivalents and advancements are within the scope of this invention.

### BRIEF DESCRIPTION OF THE DRAWINGS

FIG. 1 is a schematic diagram of a digital actuating system used to create the digital greeting of the invention.

FIG. 2 is a schematic diagram of a digital actuating system used to view the digital greetings of the invention.

FIG. 3 is a flowchart of the component parts of one example of a digital greeting of the invention.

### DETAILED DESCRIPTION OF THE INVENTION

The invention is a digital multimedia greeting including one or more types of communication such as but not limited to graphics, text, film, video, animation, images and the like, which greeting may optionally contain an interactive navigation component. The figures provided herein are illustrative of examples of devices and greetings in accordance with the invention, but it is intended that a wide variety of greetings may be made using the principles of the invention, and a wide variety of digital activating systems may be used to create and view the digital greetings of the invention. Without limiting the scope of the invention, a preferred embodiment of the invention is described below.

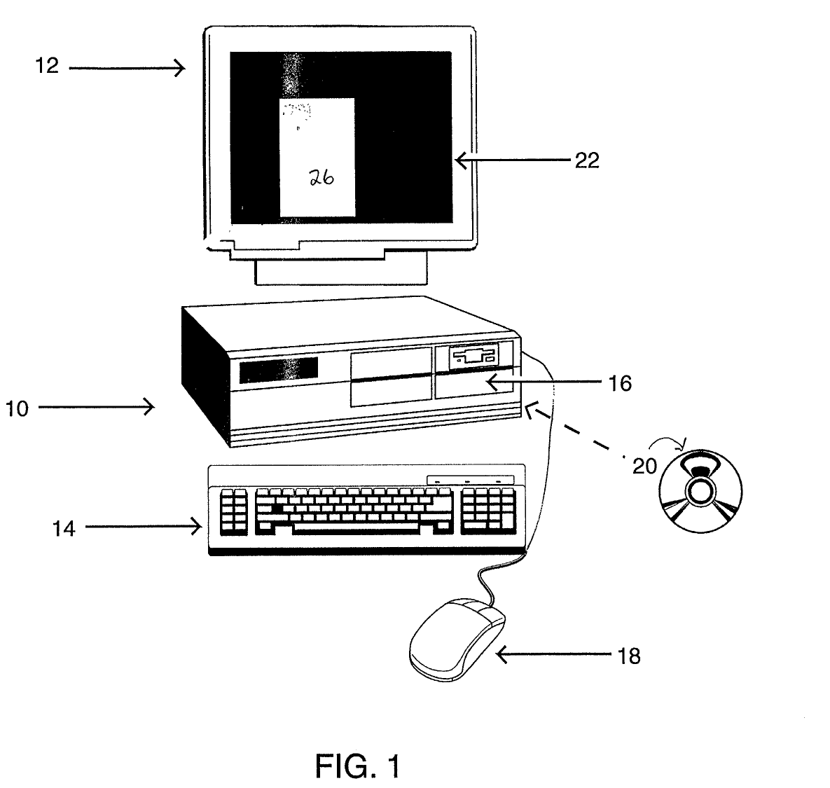

Referring now to FIG. 1, a schematic diagram of the currently preferred example of the digital actuating system 1 used to view the greetings of the invention is depicted. In this example, the recipient of the digital greeting utilizes a PC computer 10, a monitor 12, an input means such as a keyboard 14, a digital media receptacle such as CD-ROM drive 16 and mouse 18 to view the digital greeting 26 of the invention. The actuating device may optionally be equipped with internal or external speakers (not shown) if the sound component of the greeting 26 is to be actuated. To display the digital greeting of the invention, the recipient turns on the PC 10 and places the media 20 (such as a CD-ROM or DVD disk or other suitable digital media) containing the digital greeting in the digital media receptacle 16. If the PC is autorun-enabled, the recipient will open the “start” menu of the Windows® operating system and depress the “run” button from the pull-down menu by operating the mouse 18 or by pressing the appropriate keys on the keyboard 14. If the PC is not auto-run enabled, the digital greeting may be actuated from DOS by displaying the files and selecting the “greeting.exe” file. Alternatively, the viewer may select the appropriate drive on the DOS screen, and type the “run” command following the prompt by pressing the appropriate keys on the keyboard 14.

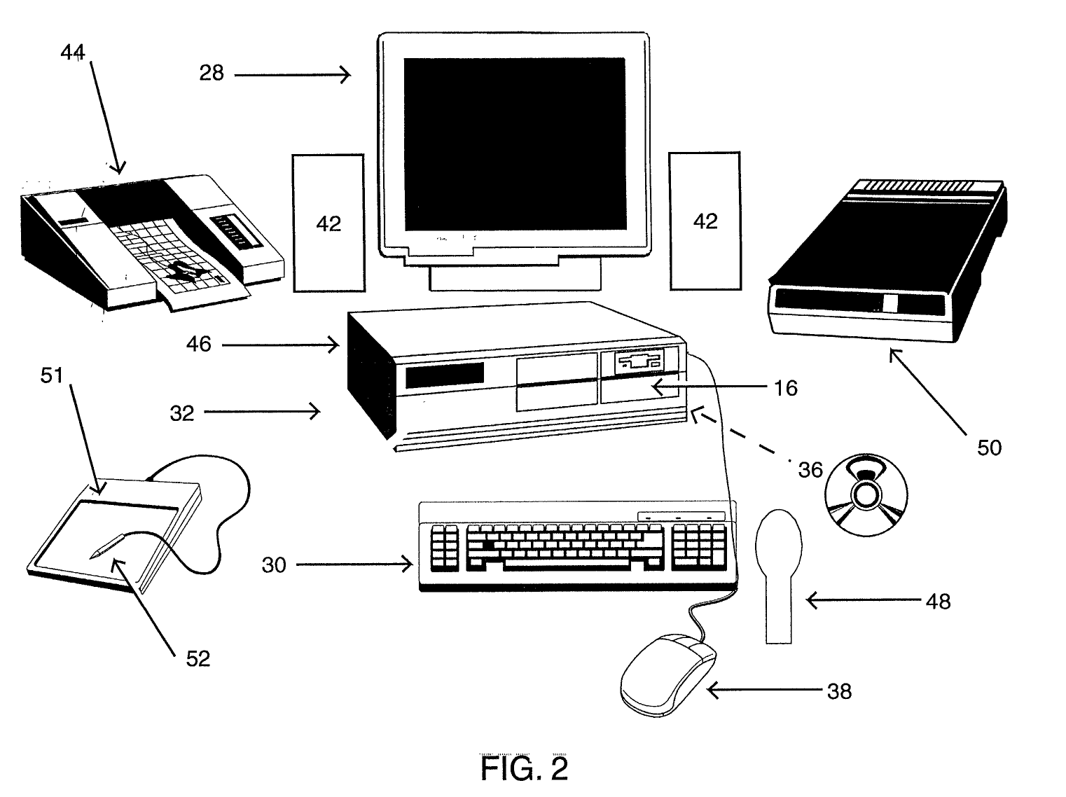

As shown in FIG. 2, the current preferred embodiment of a system for creating the digital greeting of the invention is a PC computer 32 such as an IBM PC compatible having an Intel Pentium II Processor or equivalent with MMX capabilities and a processor speed of at least 200 MHz; a 9 gigabyte hard drive with 128 megabytes of random access memory (RAM), a large capacity storage device, such as a ZIP or JAZ Drive (lomega, Corp.) a video card such as Diamond or equivalent and a Wave Table Card such as Soundblaster AWE 64 (internal components not shown). The computer 32 is in turn is connected to a color monitor 28, for example a Viewsonics 815, speakers 42, an input means such as a keyboard 30 (Standard PS2) and mouse 38 (Microsoft), a color photographic quality printer 44, a CD-ROM writer 46 such as a Yamaha DX100 and a microphone 48. The preferred embodiment may further include a scanner 50 for digitizing printed matter and a graphics tablet 51 and pen 52 which are used to create digital drawings by hand. Such drawings may then be colored and/or refined using a variety of commercially available software programs as described below. All of the items described above are commercially under a wide variety of brand names from multiple sources. While this embodiment is described using specific brands of devices, any device with equivalent functionality may be used, and for each of the above-described items, a wide variety of devices are available.

Multiple types of commercially available software are used to create the digital greetings of the invention, all of have many functional equivalents sold under differing brand names. In a preferred embodiment, the computer 32 is equipped with DOS and a Windows NT operating system (Microsoft, Redmond, WA), although other operating system software will work with the invention. To create the graphics for the digital greeting of the invention, artwork is created by hand using the graphics tablet 51 and pen 52 or scanned and digitized using the scanner 50, or it is digitally created using any commercially computer graphics program or programs such as those detailed below. The digitized artwork is then saved in a display image file with various file extensions such as but not limited to those described below.

In creating the digital greetings of the invention, a variety of commercially available software programs may be utilized. In the preferred embodiment, Adobe® Illustrator (Adobe Corp., San Jose, Calif.) may be used to create individual cels or fields of animation and to create interface screens. These illustrator files are saved as “.AI” files. Adobe® Photoshop is used to further refine illustrator drawings and apply photographic detail to vector drawn images, as well as to import scanned images. Photoshop files are saved as “.TIF”, “.BMP” and/or “.PSD” files. Ray Dream 3D® is used to create items which when displayed appear to be three dimensional (“3-D”). 3-D image files are saved as “.DXF” files, and such files may be embedded within other files of the invention, such as the animation files, for particularly striking effects. Bryce 3D® is animation software used to create animation sequences from assembled files created in RayDream® and Photoshop. The sequenced files are saved as “.AVI” files. Adobe Premier® is used to import audio files and to assemble and edit the final animation sequences, and to add such effects as fades and dissolves. Corel Click & Create® is used to create links to and to attach execution commands to multi-media files which will enable the files to be used within the Windows® operating system. The interfaced and executable files are saved as “.CCA” and “.EXE” files. Visual Basic® is used to compile stand-alone executable files and to create a user interface to play the greetings of the invention. These files are saved as “.EXE” or “.FRG” files. Sounds may be simulated using a technique known as “folley”, where sounds are created using other materials and means which are then recorded through the microphone 48 into Microsoft® Sound Recorder and digitally saved as “.WAV” files.

The final sequenced greeting can be saved as several files linked to one “.EXE” file or as a single “.EXE” file. “Autorun.inf” is an instruction command understood by Windows '95 and later Windows® operating systems to run the “.EXE” file specified in the autorun code written to the CD-ROM. Files may be sequenced within Adobe® Premier. Navigation components such as branch points are created using Visual Basic® or Corel® Click and Create.

Once the digital greeting is created and saved to one or more files, it is transferred to the digital medium, for example but not limited to CD-ROM, high capacity disk or DVD. A preferred example uses commercially available CD-ROM disks, which may be purchased in bulk by mail from the PC-Connection (Milford, N.H.), or at a retail store such as Micro-Center (Chicago, Ill. These CD-Rom disks 36 are formatted using the computer 32 as they are “written” with the digital greeting of the invention. The disks 36 are inserted into the CD-ROM drive 16 of the computer 32 and the executable greeting file is transferred to digital media via Yamaha CD Writer and saved as a “read-only” file.

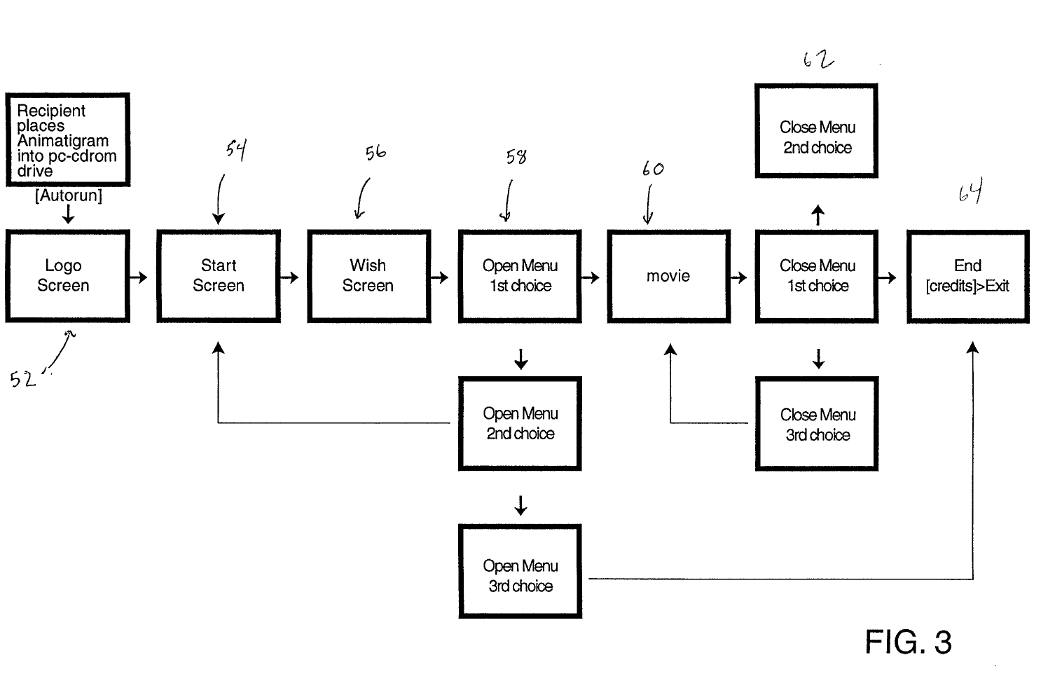

According to the preferred embodiment of the invention illustrated in FIG. 2, the finished greeting is digitally stored on a high-capacity storage medium, such as a standard 4⅝ inch CD-ROM disk 36. The greeting may optionally include one or more sound, text, animation, video or image components. To display the digital greeting of the invention, the recipient inserts the CD-ROM disk or other storage medium into the appropriate drive of a digital actuating system such as a standard personal computer 10 (as shown in FIG. 1). The greeting may then be viewed by the recipient by using the “autorun” feature now standard with any Windows95Tm or later Microsoft operating system, or by typing in a command to execute the greeting's executable file which will cause the greeting 26 to be displayed (as shown in FIG. 1). For example, in the digital greeting flowchart displayed in FIG. 3, a digital greeting begins with a logo screen 52, followed by a start screen 54. After one or more additional screens are automatically displayed, a navigation menu appears, giving the recipient several choices, including proceeding, repeating certain sections of the greeting, or saving the remainder of the greeting for another time. In the example depicted here, additional screens automatically display a “wish” (56), an interactive navigation menu having a “skip” function and a replay function 58, an animated component 60, a second navigation menu 62 and an end screen 64. The recipient may use the menu to replay a portion of the greeting, to proceed, or to scroll through all screens of the greeting. Navigation selections may also be used to skip portions of the greeting. Additional parts of a greeting may include various functions such as, for example, an animated visit through a castle with sound and a talking frog, if the greeting is for a child. The scope of the invention includes components and functions suitable for different occasions and different persons, and these variations on the embodiment described herein are within the scope of the invention.

The reader will appreciate that the feature and flowchart of other greetings of the invention will differ, just as the content of traditional paper greeting cards varies. The greetings of the invention may be adapted to any situation or language, and unlike traditional greeting cards which must be read, the digital greetings of the invention have a visual and an audio component. The digital greetings may also incorporate video, photography and animation, and will thus appeal to a wide range of variously skilled recipients. Unlike traditional paper greeting cards, the digital greetings of the invention are packaged in a case rendering matching envelopes unnecessary, and digital media may be extensively handled without damage. Lastly, the novel digital greetings of the invention provide a keepsake that may be enjoyed and redisplayed for many years.

While the invention has been described in connection with a preferred embodiment, it is not intended to limit the scope of the invention to the particular form set forth, but, on the contrary, it is intended to cover such alternatives, modifications, and equivalents as may be included within the spirit and scope of the invention as defined in the claims.

I claim:

1. A digital multi-media greeting comprising:
a text component; and
a graphics component; and
one or more of film component, an animation component, a sound component, an image component, and a video component;
whereas the greeting is digitally contained on a physical medium that is readable by a digital activating system adapted to accept the medium and the greeting is displayed to the recipient on a digital display medium.

2. The digital greeting of claim 1 wherein the digital greeting may be automatically displayed.

3. The digital greeting of claim 1 wherein digital activating system is a computer, the medium is a CD-ROM disk, and the text and graphics components and optional components are individual machine-readable digital files, and the digital display medium is a computer screen.

4. The digital greeting of claim 1, wherein the components are contained within a single executable software file.

5. The digital greeting of claim 1 wherein the greeting may be optionally actuated by the recipient.

6. The digital greeting of claim 1 wherein the greeting further comprises at least one navigation menu component consisting of navigation functions which enable the recipient to navigate through the greeting and to replay one or more components of the greeting and to skip one or more components of the greeting.

7. The digital greeting of claim 1, wherein the components are saved to the medium as individual software files and connected in a sequence, and wherein the sequence is actuated to execute in a predetermined order by an executable file.

8. The digital greeting of claim 7 wherein the greeting contains an autoexecutable function.

9. A method for creating a digital greeting using a computer comprising the steps of:
a. creating digital graphic design files;
b. creating digital text files;
c. creating one or more sound, animation, video or image files;
d. linking the created files to form a digital greeting;
e. creating at least one executable file for the greeting; and
f. transferring the digital greeting to a digital medium and saving the greeting in a “read-only” format.

10. The method of claim 9 wherein the digital greeting further comprises at least one navigation menu where the viewer selects navigation functions to navigate through the software files of the digital greeting.

11. The method of claim 9 wherein the digital medium is CD-ROM or digital video disk.

12. The method of claim 9 wherein the digital greeting further comprises an autoexecutable function.

13. The digital greeting of claim 9 wherein the greeting further comprises a menu component consisting of navigation commands which enable the recipient to navigate through the greeting and to replay one or more components of the greeting and to skip one or more components of the greeting.

14. A digital multi-media greeting comprising one or more software files containing:
at least one graphic component;
at least one text component;
at least one animation component;
at least one sound component;
an autoexecutable instruction; and
at least one executable file linked to the graphic, text, animation and sound components, wherein a computer having autorun capability could automatically run the digital greeting and further wherein the greeting may optionally contain one or more navigation functions which enable interactive navigation through the greeting and a replay capability and a skip capability, wherein the digital greeting may further comprise at least one video file.
